(19) United States
(12) Patent Application Publication
(10) Pub. No.: US 2013/0318177 A1
(43) Pub. Date: Nov. 28, 2013

(54) SYSTEMS AND METHODS FOR PORTFOLIO MONITORING

(71) Applicant: Brand Enforcement Services Limited, Hong Kong (CN)

(72) Inventor: Edwin Tan, Beaverton, OR (US)

(73) Assignee: Brand Enforcement Services Limited, Hong Kong (CN)

(21) Appl. No.: 13/831,603

(22) Filed: Mar. 15, 2013

Related U.S. Application Data
(60) Provisional application No. 61/652,084, filed on May 25, 2012.

(51) Int. Cl. H04L 12/26

(52) U.S. Cl. CPC H04L 43/08; H04L 51/28
USPC 709/206; 709/224

(57) ABSTRACT

Systems and methods for determining portfolio monitoring are provided. More specifically, various embodiments of the present invention relate to systems and methods for monitoring a portfolio of domain names for expiration, availability, and collection of redirection analytics. In some embodiments, a portfolio monitoring system can provide change warnings about various domain names along with historical information (e.g., ownership, snapshots, valuation, redirection analytics, etc.) about the domains. This information can be used in making an automated or manual decision to purchase or renew the domain name.

### CROSS-REFERENCE TO RELATED APPLICATIONS

This application claims priority to U.S. Provisional Application Ser. No. 61/652,084 filed May 25, 2012, which is incorporated herein by reference for all purposes.

### TECHNICAL FIELD

Various embodiments of the present invention generally relate to systems and methods for monitoring a portfolio of domain names. More specifically, various embodiments of the present invention relate to systems and methods for monitoring a portfolio of domain names for expiration, availability, and collection of redirection analytics.

### BACKGROUND

IP addresses can be identified by names that are more easily recognizable by humans. These names, referred to as domain names, are used in URLs to identify websites. Every domain name has a suffix indicating a top level domain (TLD) to which the domain is associated. Common examples of TLD include com, edu, mil, net, and gov. When a user of the Internet types a domain name into a browser, a domain name server is used to determine the IP address that is associated with a domain name. Using the IP address, the appropriate website can be delivered to the user.

Domain names must be registered or purchased. The registration period only lasts for a limited time and must be renewed. It is not uncommon for companies or individuals to have a large portfolio of domain names. Traditional systems do not provide adequate solutions for keeping track of the expiration date of domain names. Consequently, improved techniques are needed for effectively monitoring a portfolio of domain names.

### SUMMARY

Various embodiments of the present invention generally relate to systems and methods for monitoring a portfolio of domain names. More specifically, various embodiments of the present invention relate to systems and methods for monitoring a portfolio of domain names for expiration, availability, and collection of redirection analytics. In some cases, quarantined e-mails with domain names that correspond to websites that are being redirected may also be redirected in a safe manner.

In accordance with various embodiments of the present invention, a set of domain names relating to one or more trademarks may be identified. The set of domain names that are identified may include variants of trademarks (e.g., phonetic or typographical), cybersquatting domain names, same ownership determined by WHOIS, and others. The websites associated with the set of domain names may be monitored. In some cases, the monitoring includes recording historical traffic information, historical WHOIS information, snapshots of the websites, and other available information.

An availability list can be created that identifies one or more of the domain names in the set of domain names that are about to expire and become available for purchase. An availability notification may be generated for each of the one or more domain names in the availability list. The user can review any of the historical information (e.g., historical traffic information or website snapshots) during their evaluation.

In some embodiments, a portfolio monitoring system can include a monitoring module, a tracking module, a timing module, a graphical user interface module, a redirection analytics module, a valuation module, and/or a suggestion module. The monitoring module may be configured to monitor primary domain names associated with trademark registrations and with variants of the primary domain names. The tracking module may be configured to determine and record traffic information for the primary domain names and the variants of the primary domain names. The timing module may be configured to determine when the primary domain names and the variants of the primary domain names will become available for purchase.

The graphical user interface module may be configured to use a processor to generate a graphical user interface screen with a set of lapse indicators indicating the possibility of registration with respect to the primary domain names or with the variants of the primary domain names. In some cases, the lapse indicators may be based on information supplied by the timing module. In addition, the graphical user interface screen may also include the traffic information recorded by the tracking module for each primary domain name or variant of the primary domain name that will become available for purchase.

The redirection analytics module may be used to track redirection statistics from the primary domain names or the variants of the primary domain names. The valuation module may estimate the value of the redirection from the primary domain names or the variants of the primary domain names based on the redirection statistics tracked by the redirection analytics module. The suggestion module can suggest variations of the primary domain names. The purchasing module may receive purchase and renewal instructions from a user regarding the primary domain names and the variants of the primary domain names and to execute the purchase and renewal instructions.

A computer-implemented method, in accordance with various embodiments, can include monitoring a selected set of domain names using a monitoring engine. The monitoring may include recording statistical traffic information and revenue generation along with other information about the domain name. An expiration date may be determined for each domain name in the selected set of domain names. Then, using a processor, an expiration report may be generated that includes the expiration date, the statistical traffic information, and the revenue generation for each domain name.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF DRAWINGS

Embodiments of the present invention will be described and explained through the use of the accompanying drawings in which:

FIG. 1 illustrates an example of an environment in which an Internet-based portfolio monitoring system in accordance to some embodiments may be utilized;

FIG. 2 shows a block diagram with exemplary components of a portfolio monitoring system in accordance with one or more embodiments of the present invention;

FIG. 3 is a flowchart illustrating exemplary operations for renewing or purchasing expiring domain names in accordance with various embodiments of the present invention;

FIG. 4 is a flowchart illustrating exemplary operations for generating a set of one or more domain names to monitor in accordance with some embodiments of the present invention;

FIG. 5 is a flowchart illustrating exemplary operations for renewing or purchasing a domain name in accordance with various embodiments of the present invention;

FIG. 6 is a flowchart illustrating exemplary operations for monitoring websites in accordance with one or more embodiments of the present invention;

FIG. 7 is a flowchart illustrating exemplary operations for redirecting e-mails in accordance with some embodiments of the present invention; and

FIG. 8 illustrates an example of a computer system with which one or more embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION OF THE INVENTION

Various embodiments of the present invention generally relate to systems and methods for monitoring a portfolio of domain names. More specifically, various embodiments of the present invention relate to systems and methods for monitoring a portfolio of domain names (whether currently owned by the user or not) for expiration, availability, and/or collection of redirection analytics. In some embodiments, a portfolio monitoring system can provide change warnings about various domain names along with historical information about the domains. For example, a user can set an alert threshold and add domain names to be monitored. The system may suggest even more domain names (e.g., based on WHOIS of an initial domain name). A WHOIS search can return a variety of useful data which can be monitored. For example, the system can monitor for changes in Creation Date, Registration Date, Expiry Date, Last Update Organization Name, Organization Address, Admin Name, Admin E-mail, Admin Phone, and other fields of information.

Any detection of changes in the one or more of these fields can result in the system generating alerts or warnings, which can be delivered via e-mail, phone, fax, SMS message, in a report, etc. In addition, the system can create a change history of all changes for each domain name in the portfolio. In addition, some embodiments of the present invention collect screenshots of the websites on a regular basis, predetermined schedule, or upon detection of an event.

In addition to monitoring changes to the website, various embodiments of the present invention can record and monitor changes in domain name traffic to generate redirection analytics. For example, some domain names within a portfolio do not serve active functions (e.g., names that were recovered in UDRP action). Instead, the owner may be redirecting all traffic from these websites to their main domain name. As an example, common misspellings such as “trupadvisor.com” as opposed to “tripadvisor.com” would be redirected to “tripadvisor.com”. As redirections occur, statistical information can be collected. In some cases, a list of statistics can be seen as per services of multiple existing analytics companies. In some embodiments, the user can input or associate a dollar figure for different demographic visitor (e.g., physical region), and the system can produce a total cost per time period.

Some embodiments of the present invention provide for evaluating and redirecting e-mails from various e-mail quarantines. For example, for the domain names that do not serve an active function (i.e., they simply redirect to a main website), the system can capture and temporarily store (may delete after 30 days) all e-mails headed into that domain name. In one or more embodiments, the e-mails may be forwarded in image form or in text form, but might be sanitized (attachments stripped). Warnings may be optionally appended to e-mails in some cases. For example, a link may be embedded in a sanitized e-mail and used to initiate full delivery of an actual e-mail message and/or an image thereof.

In some cases, the domain name may be a variant of the main domain name. When the local part of an e-mail matches that of a real user, but the domain name within the e-mail address appears to be a typographical error, the system may correct or replace the domain name with the main domain name. For example, localpart@trupadvisor.com may be replaced with localpart@tripadvisor.com. In the case where the local part is not recognized, e.g., ajfhbaebf@trupadvisor.com, the system can quarantine, forward to an administrative user, and/or allow a user to view online in list form just like an inbox.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

While, for convenience, embodiments of the present invention are described with reference to domain name portfolio monitoring, embodiments of the present invention are equally applicable to various other brand related elements such as, but not limited to, slogans, products, product price points, and others. In addition, various embodiments of the present invention are also applicable to processing various reporting and monitoring services, pricing structures (e.g., allowing access to different features and/or tiers of service), distribution and delivery models (e.g., distributed computing or stand alone applications), and/or interfaces.

The techniques introduced here can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

### General Description

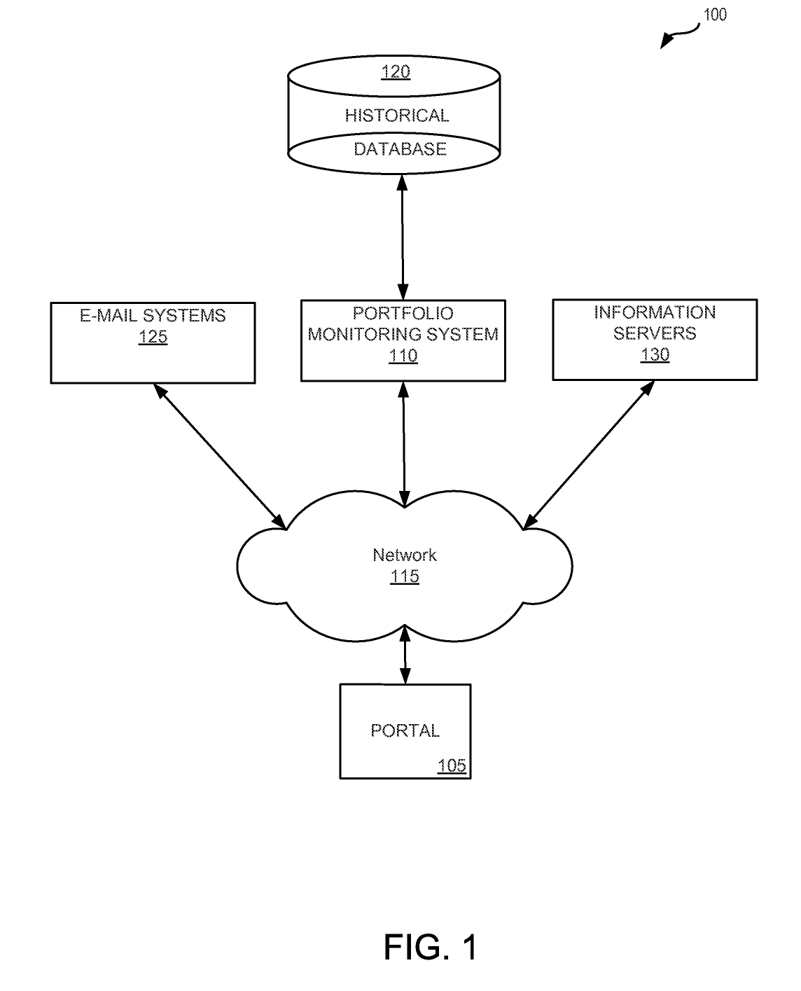

FIG. 1 illustrates an example of an environment 100 for Internet-based portfolio monitoring in which some embodiments of the present invention may be utilized. The environment 100 illustrated in FIG. 1 includes a portal 105, portfolio monitoring system 110, network 115, historical database 120, e-mail systems 125, and information servers 130 (e.g., WHOIS). A user can access portfolio monitoring system 110 through portal 105. In some embodiments, one or more graphical user interfaces may be provided for displaying and submitting information.

Portfolio monitoring system 110 can be used for monitoring the status of a portfolio of domain names. The portfolio of domain names can include any type of domain names such as domain names owned by the user, domain names recovered from a legal action, domain names of interest to the user, etc. In some embodiments, any changes in the status (e.g., ownership, content changes, expiration status, etc.) can be identified by portfolio monitoring system 110. These changes can be used to generate various notifications which may be presented to the user through portal 105.

Historical database 120 may be used to store snapshots and other information (e.g., collected from information servers 130) about the domain names over various time periods. In some cases, historical database 120 can include a collection of e-mails messages for evaluation. The e-mail messages can be aggregated from e-mail systems 125. The portfolio monitoring engine can monitor how the e-mails and websites mentioned within the e-mails change over time.

The portfolio monitoring system 110 may use the Internet to capture snapshots of the websites that can be stored within the historical database 120. In some embodiments, portfolio monitoring system 110 can provide change warnings about various domain names along with historical information about the domains. For example, a user can set an alert threshold and add domain names to be monitored. The system may suggest even more domain names (e.g., based on WHOIS of initial domain name). A WHOIS search can return a variety of useful data that can be monitored over time. For example, the system can monitor for changes in Creation Date, Registration Date, Expiry Date, Last Update Organization Name, Organization Address, Admin Name, Admin E-mail, Admin Phone, and other fields of information.

Any detection of changes in the one or more of these fields can result in the system generating alerts or warnings, which can be delivered via e-mail, phone, etc. In addition, the system can create a change history of all changes for each domain name in the portfolio. In addition, some embodiments of the present invention collect screenshots of the websites on a regular basis, predetermined schedule, or upon detection of an event. Comparisons can be run, in one or more embodiments, between the screenshots. The changes detected can trigger alerts or warnings. In addition, these screenshots can be compared to screenshots from other domains to determine a similarity score.

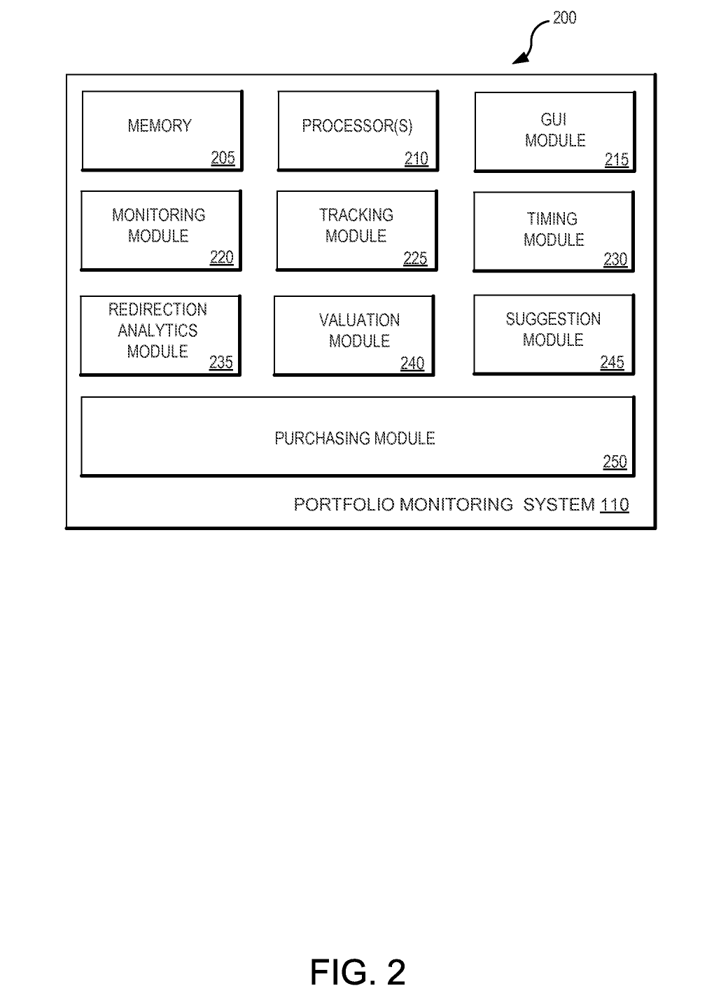

FIG. 2 shows a block diagram 200 with exemplary components of portfolio monitoring system 110 in accordance with one or more embodiments of the present invention. According to the embodiments shown in FIG. 2, the portfolio monitoring system can include memory 205, one or more processors 210, graphical user interface (GUI) generation module 215, monitoring module 220, tracking module 225, timing module 230, redirection analytics module 235, valuation module 240, suggestion module 245, and purchasing module 250. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, monitoring module 220 and tracking module 225 may be combined into a single module.

Memory 205 can be any device, mechanism, or populated data structure used for storing information. In accordance with some embodiments of the present invention, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 205.

Memory 205 may be used to store instructions for running one or more applications or modules on processor(s) 210. For example, memory 205 could be used in one or more embodiments to house all or some of the instructions needed to execute the functionality of GUI generation module 215, monitoring module 220, tracking module 225, timing module 230, redirection analytics module 235, valuation module 240, suggestion module 245, and purchasing module 250.

In accordance with various embodiments, GUI generation module 215 can generate one or more GUI screens that allow for interaction with a user of the portfolio monitoring system. These interactions can include receiving instructions from the user (e.g., which domain names to monitor, renew, or purchase) and presenting information to the user (e.g., regarding upcoming expiration of domain names).

In at least one embodiment, GUI generation module 215 generates a graphical user interface allowing submission of trademarks. The trademarks may be submitted to the portfolio monitoring system for evaluation. The portfolio monitoring system can return one or more domain names (which may or may not be owned by the user) that may be of interest. The user is then able to select which domains to monitor. In some cases, the user can also associate notification criteria with each domain name. Examples of notification criteria include, maximum price the user is willing to pay for the domain name, an expiration notification buffer time (e.g., a time period, such as one month, before the expiration of the domain name), and others.

In one embodiment, GUI generation module 215 may generate a dashboard detailing the results, pending notifications, domain name status changes (e.g., ownership, website update, etc.), and/or traffic information from the portfolio monitoring system. The dashboard can indicate which of the multiple domain names are potential cybersquatters. The dashboard may include a set of lapse indicators indicating the possibility of registration with respect to the primary domain names or with the variants of the primary domain names. In some embodiments, the dashboard may also generate requests for purchasing the websites (e.g., from a website auction).

Monitoring module 220 may be configured to monitor primary domain names associated with trademark registrations and with variants of the primary domain names. For example, monitoring module may perform a WHOIS search. A variety of data from this search can be monitored over time. For example, the system can monitor for changes in Creation Date, Registration Date, Expiry Date, Last Update Organization Name, Organization Address, Admin Name, Admin E-mail, Admin Phone, and other fields of information. In addition, monitoring module 220 may take snapshots of the website and/or record copies of the html code associated with the domain name.

Tracking module 225 may be configured to determine and record traffic information for the primary domain names and the variants of the primary domain names. For example, within a portfolio there may be many domain names that are used to redirect a user to the main domain name. Tracking module 225 can monitor the traffic that flows through these other domain names to the main domain name. This information can be used by redirection analytics module 235 to generate redirection statistics from the primary domain names or the variants of the primary domain names. Suggestion module 245 may suggest variations of the selected domain names allowing the user to decide whether these domains should also be monitored and tracked.

Timing module 230 may be configured to determine when the primary domain names and the variants of the primary domain names will become available for purchase. An estimate of the value of each domain name can be estimated by valuation module 240. Valuation module 240 can use information about the domain names and websites (e.g., traffic information, similarity to trademark names, historical purchase prices, likelihood of confusion by an end-user, and other internal or external factors) in generating a value or value range. In some embodiments, valuation module 240 can use one or more automated valuation models or methods (e.g., mathematical models, heuristics, or hedonic models) to calculate the value or value range. Purchasing module 250 can receive purchase and renewal instructions from a user regarding the primary domain names and the variants of the primary domain names and then execute the purchase and renewal instructions.

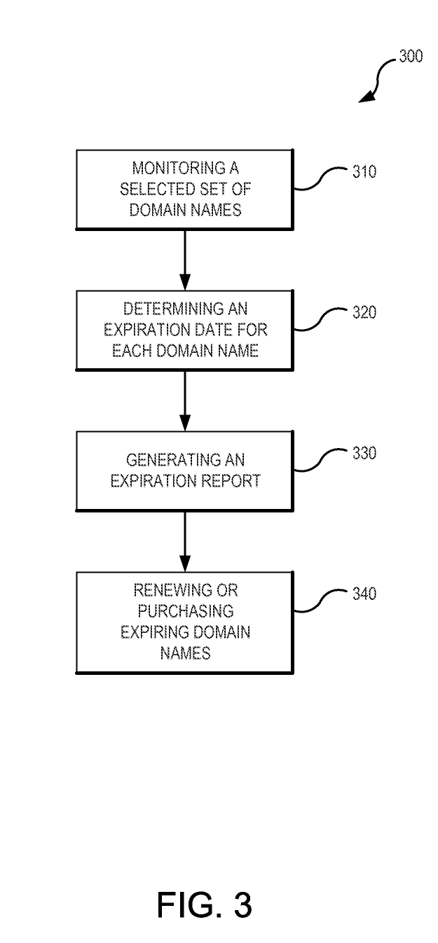

FIG. 3 is a flowchart illustrating exemplary operations 300 for renewing or purchasing expiring domain names in accordance with various embodiments of the present invention. One or more of the operations illustrated in FIG. 3 can be performed by processor(s) 210, monitoring module 220, timing module 230, or purchasing module 250. As illustrated in FIG. 3, monitoring operation 310 monitors a selected set of domain names. A user of the portfolio monitoring system, for example, could select the domain names of interest through graphical user interface. The monitoring can include monitoring one or more fields from a WHOIS search, recording snapshots of the associated websites over time, monitoring for trademark infringement, and other steps for collecting information about the website. The information collected from monitoring operation 310 can be recorded in one or more databases for future reference or during an evaluation operation.

Expiration operation 320 determines an expiration date for each domain name in the selected set of domains. Using this information, reporting operation 330 generates an expiration report. The expiration report can be presented to the user through a graphical user interface (e.g., generated by GUI generation module 215). Within the report the user can be presented with summaries of the information collected using monitoring operation 310. For example, the user can view the website, changes to the website over a specified time period traffic analytics, ownership information, results from trademark infringement analyses, a valuation of the website, and other information. The user can review the report and determine if the website should be renewed or purchased using acquisition operation 340. The user may request that the system provide future reminders, automatically bid on and/or purchase the domain name, continue monitoring, etc.

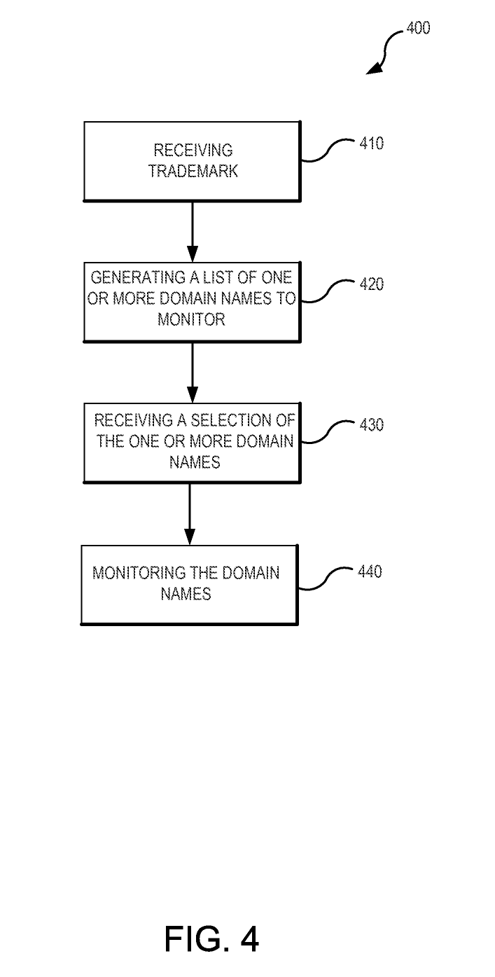

FIG. 4 is a flowchart illustrating exemplary operations 400 for generating a set of one or more domain names to monitor in accordance with some embodiments of the present invention. As illustrated in FIG. 4, receiving operation 410 receives a trademark for evaluation. In some embodiments, receiving operation 410 can include the submission (or identification) of a trademark through a graphical user interface screen generated by GUI generation module 215. Using the trademark, a list of one or more domain names can be suggested (e.g., using suggestion module 245) for monitoring. For example, the suggestions can include typographical variants and/or phonetically similar domain names. The user can select which of the suggested domain names are to be monitored with selection operation 430. Then, monitoring operation 440 can monitor the domain names (e.g., using monitoring module 220).

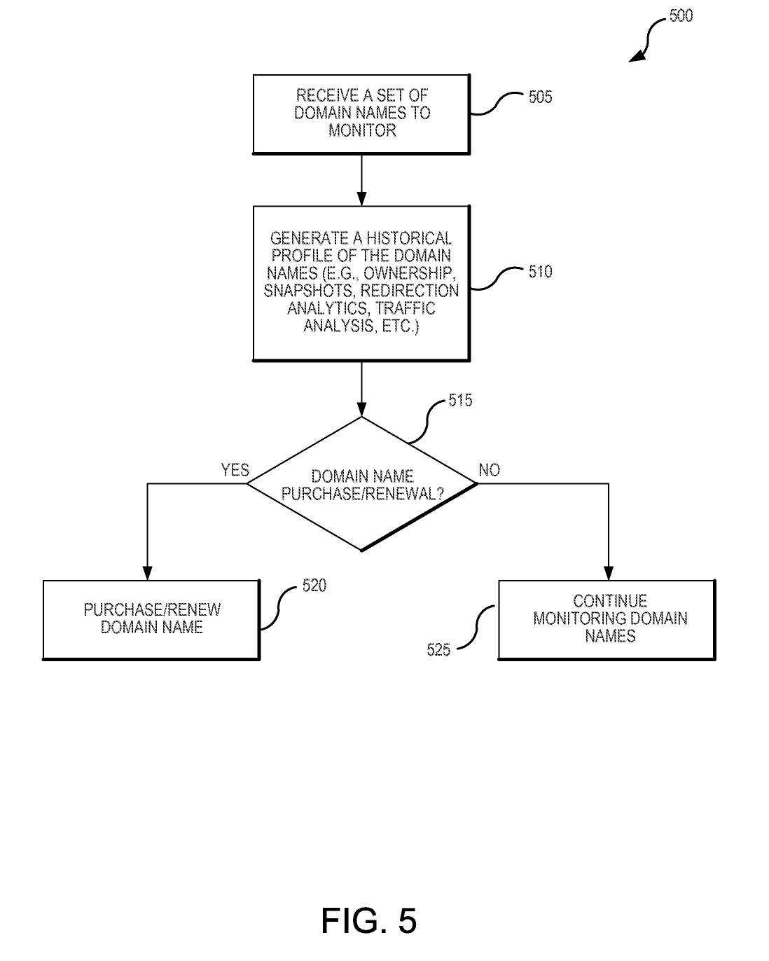

FIG. 5 is a flowchart illustrating exemplary operations 500 for renewing or purchasing a domain name in accordance with various embodiments of the present invention. A set of domain name to be monitored can be received with receiving operation 505. Profiling operation 510 can then generate a historical profile of the domain names. The historical profile can include ownership, snapshots of associated website, redirection analytics, a traffic analysis, a valuation analysis, and other information. The user can manually select, or setup automated criteria, for the purchase or renewal of a domain name using decision operation 515. If a decision is made to purchase or renew the domain name, decision operation 515 branches to purchase/renewal operation 520. If a decision is made to not purchase the domain name, decision operation 515 branches to monitoring operation 525 where the domain names are continued to be monitored.

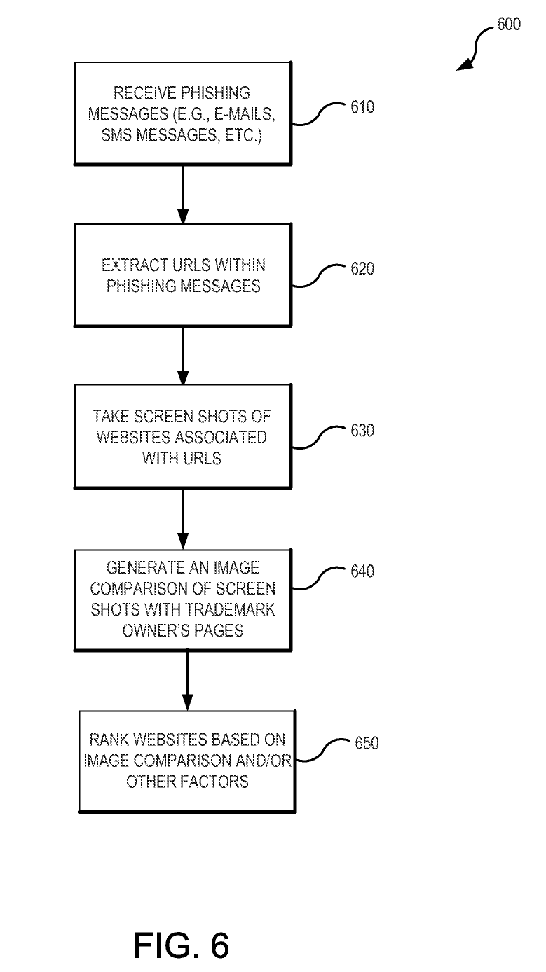

FIG. 6 is a flowchart illustrating exemplary operations 600 for monitoring websites in accordance with one or more embodiments of the present invention. As illustrated in FIG. 6, receiving operation 610 can receive messages (e.g., phishing e-mails) that have URLs to domain names that are variants (e.g., having a misspelling) of a domain name being monitored. For example, the messages received during receiving operation 610 can be messages reported by individuals, spam filters, or may be part of a reply e-mail to a variant domain name. In other embodiments, phishing messages can be attracted to monitored e-mail addresses, telephone numbers, or other ways of communication. For example, these e-mails addresses and telephone numbers can be liberally made available to either known places where the address are harvested, or to less than reputable sites, in order to attract phishing messages which can then be evaluated. As one example, phishing messages are often targeted to large universities or companies that have standardized patterns for the local part of the e-mail address (e.g., first letter of a first name of a user followed by the full last name). An e-mail address could be setup with an easily guessed or standard local part following the format most commonly used by the university or organization.

Extraction operation 620 extracts any URLs within the suspicious messages. Then capture operation 630 takes screen shots of the websites associated with the URLs. These screen shots can be compared with screen shots of domain name owner or trademark owner's real website during comparison operation 640. In some embodiments, comparison operation 640 may generate a score based on the comparison. For example, a high similarity of style, color, organization, company logo, or the like may be used to score the websites higher. In some embodiments, there can be different levels, hierarchy, or types of comparisons that can be made.

Ranking operation 650 can rank the websites based on the image comparison, generated score, and/or other factors. A high rank will indicate a need for manual review, further monitoring, further information gathering, and/or an action to be taken (e.g., a cease and desist letter). In addition, the domain owners may also indicate a priority level which can be used in ranking the suspicious websites. In some embodiments, the screen shots may be forwarded to a reviewer along with other information such as the ranking, suspicious message, etc.

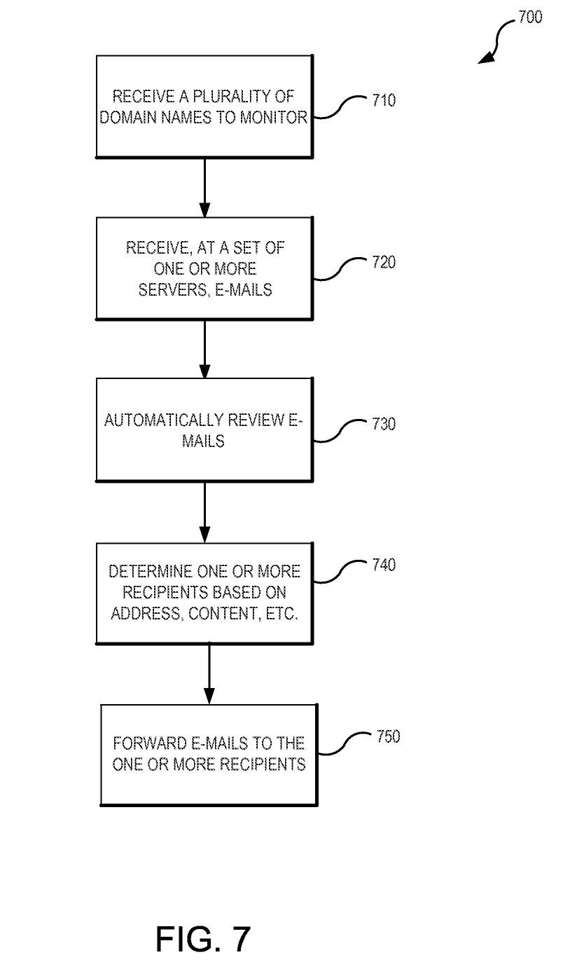

FIG. 7 is a flowchart illustrating exemplary operations 700 for determining destinations for redirecting e-mails in accordance with some embodiments of the present invention. Receiving operation 710 receives an indication of a plurality of domain names to monitor for e-mail redirection. These e-mails can be received during operation 720 at one or more servers and automatically reviewed during analysis operation 730. Determination operation 740 determines the correct e-mail recipient based on the address, content, etc. Forwarding operation 750 then forwards the e-mails (or an image of the e-mail) to the one or more recipients.

For example, in some cases, the domain name indicated in the e-mail address may be a variant of the main domain name. When the local part of an e-mail matches that of a real user, but the domain name within the e-mail address appears to be a typographical error, determination operation 740 may determine that the e-mail should be directed to the real user at the correct domain name. For example, user1@trupadvisor.com may be replaced with user1@tripadvisor.com. As another example, when determination operation 740 determines the local part does not correspond to a real user, e.g., ajfhbaebf@trupadvisor.com, the system can quarantine, forward (e.g., using forwarding operation 750) to an administrative user, or allow a reviewer to view the e-mail online in list form just like an inbox. Still yet, other information such as the content of the e-mail can be used to determine the appropriate destination.

### Exemplary Computer System Overview

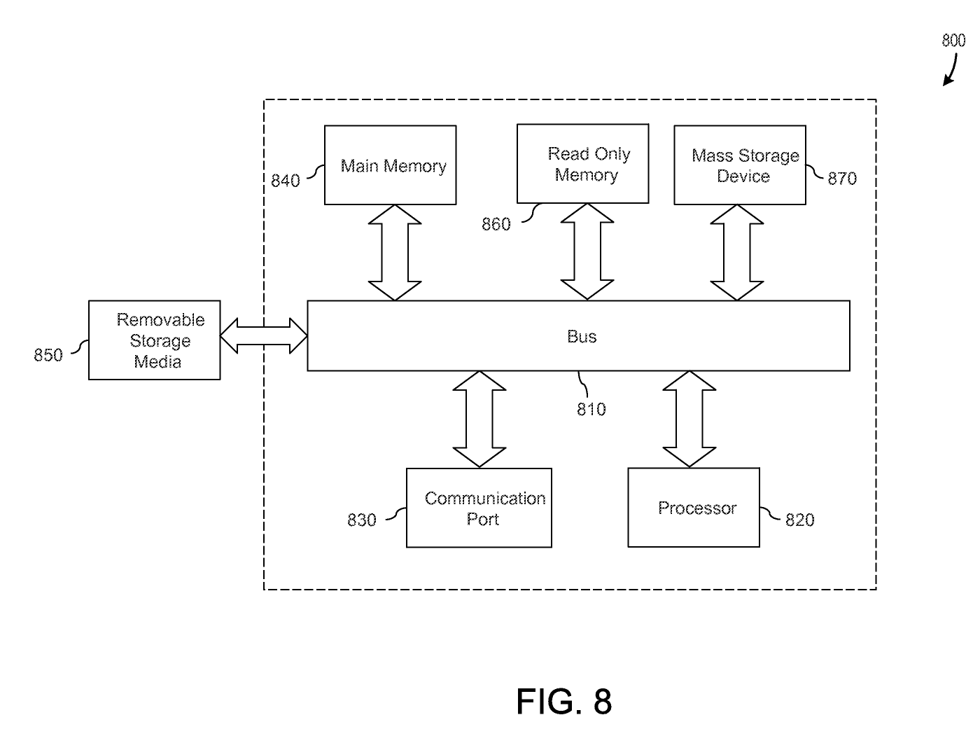

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 8 is an example of a computer system 800 with which embodiments of the present invention may be utilized. According to the present example, the computer system includes a bus 810, at least one processor 820, at least one communication port 830, a main memory 840, a removable storage media 850, a read only memory 860, and a mass storage 870.

Processor(s) 820 can be any known processor, such as, but not limited to, an Intel® Itanium® or Itanium 2® processor(s), or AMD® Opteron® or Athlon MP® processor(s), or Motorola® lines of processors. Communication port(s) 830 can be any of an RS-232 port for use with a modem based dialup connection, a 10/100 Ethernet port, or a Gigabit port using copper or fiber. Communication port(s) 830 may be chosen depending on a network such a Local Area Network (LAN), Wide Area Network (WAN), or any network to which the computer system 800 connects.

Main memory 840 can be Random Access Memory (RAM), or any other dynamic storage device(s) commonly known in the art. Read only memory 860 can be any static storage device(s) such as Programmable Read Only Memory (PROM) chips for storing static information such as instructions for processor 820.

Mass storage 870 can be used to store information and instructions. For example, hard disks such as the Adaptec® family of SCSI drives, an optical disc, an array of disks such as RAID, such as the Adaptec family of RAID drives, or any other mass storage devices may be used.

Bus 810 communicatively couples processor(s) 820 with the other memory, storage and communication blocks. Bus 810 can be a PCI/PCI-X or SCSI based system bus depending on the storage devices used.

Removable storage media 850 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for monitoring portfolios of domain names. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations that fall within the scope of the claims, together with all equivalents thereof. Therefore, the above description should not be taken as limiting the scope of the invention, which is defined by the appended claims.

What is claimed is:

1. A method comprising:
identifying a set of domain names relating to one or more trademarks;
monitoring websites associated with the set of domain names, wherein the monitoring includes recording historical traffic information;
determining an availability list that identifies one or more of the domain names in the set of domain names that are about to become available for purchase; and
generating an availability notification for each of the one or more domain names in the availability list, wherein the notification includes the historical traffic information collected for each website.

2. The method of claim 1, wherein the set of domain names include variants of trademarks.

3. The method of claim 2, wherein the variants of the trademarks include typographical variants.

4. The method of claim 1, wherein the set of domain names include cybersquatting domain names.

5. The method of claim 1, wherein monitoring the websites includes recording snapshots of the websites over time.

6. The method of claim 1, wherein identifying the set of domain names includes parsing e-mails sent to invalid e-mail addresses and identifying domain names contained in the e-mails or e-mail addresses.

7. The method of claim 1, further comprising purchasing a subset of the one or more of the domain names.

8. The method of claim 7, further comprising:
receiving an e-mail directed to one of the purchased domain names;
determining, from an e-mail address of the e-mail, one or more valid e-mail addresses where the e-mail should be forwarded; and
forwarding an image of the e-mail or the e-mail to the one or more valid e-mail addresses.

9. The method of claim 1, wherein monitoring the websites includes monitoring advertising traffic.

10. The method of claim 1, wherein identifying a set of domain names includes using WHOIS to determine ownership of each domain name and suggesting additional domain names based on ownership.

11. A portfolio monitoring system comprising:
a monitoring module configured to monitor primary domain names associated with trademark registrations and with variants of the primary domain names;
a tracking module configured to determine and record traffic information for the primary domain names and the variants of the primary domain names;
a timing module configured to determine when the primary domain names and the variants of the primary domain names will become available for purchase; and
a graphical user interface module configured to use a processor to generate a graphical user interface screen with a set of lapse indicators indicating the possibility of registration with respect to the primary domain names or with the variants of the primary domain names based on information supplied by the timing module, wherein the graphical user interface screen also includes the traffic information recorded by the tracking module for each primary domain name or variant of the primary domain that will become available for purchase.

12. The portfolio monitoring system of claim 11, further comprising a redirection analytics module to track redirection statistics from the primary domain names or the variants of the primary domain names.

13. The portfolio monitoring system of claim 12, further comprising a valuation module to estimate the value of the redirection from the primary domain names or the variants of the primary domain names based on the redirection statistics tracked by the redirection analytics module.

14. The portfolio monitoring system of claim 11, further comprising a suggestion module to suggest variations of the primary domain names.

15. The portfolio monitoring system of claim 14, wherein the graphical user interface module is configured to generate a suggestion screen upon receive the variations of the primary domain names from the suggestion module.

16. The portfolio monitoring system of claim 11, wherein the graphical user interface screen include a monitoring status for each domain name, the monitor status including a decline status and a track status indicating the user previously declined or requested to further monitor or track each domain name.

17. The portfolio monitoring system of claim 16, wherein the graphical user interface screen allows the user to change the monitoring status of each domain name.

18. The portfolio monitoring system of claim 16, wherein the tracking module only tracks primary domain names and variants of the primary domain names with a track status.

19. The portfolio monitoring system of claim 11, further comprising a purchasing module to receive purchase and renewal instructions from a user regarding the primary domain names and the variants of the primary domain names and to execute the purchase and renewal instructions.

20. The portfolio monitoring system of claim 11, wherein the monitoring module monitors auction sites and/or other vendors for offerings of the primary domain names or variants of the primary domain names.

21. A computer-implemented method comprising:
monitoring, using a monitoring engine, a selected set of domain names, wherein the monitoring includes recording statistical traffic information and revenue generation;
determining an expiration date for each domain name in the selected set of domain names; and
generating, using a processor, an expiration report that includes the expiration date, the statistical traffic information, and the revenue generation for each domain name.

22. The computer-implemented of claim 21, further comprising:
receiving a trademark and generating a list of possible domain names of interest;
presenting the list of possible domain names of interest to a user; and
receiving a selection from the user regarding which domain names from the list of possible domain names of interest should be added to the selected set of domain names.

23. The computer-implemented of claim 22, wherein generating a list of possible domain names includes typographical variants of the trademark.

24. The computer-implemented of claim 22, further comprising collecting a set of quarantined e-mails and wherein generating a list of possible domain names includes searching the e-mails for cybersquatting domain names or phishing domain names.

25. The computer-implemented of claim 21, wherein monitoring the selected set of domain names includes taking snapshots of web pages associated with the domain names.

26. The computer-implemented of claim 21, wherein the expiration report includes the snapshots of the web pages.

27. The computer-implemented of claim 21, wherein the expiration report is presented through a graphical user interface on a terminal device.

28. The computer-implemented of claim 21, further comprising identifying e-mails with a domain name from the selected set of domain names and redirecting the e-mails to an e-mail address with an identical local part and a different domain name.

29. A system comprising:
a means for identifying a set of domain names relating to one or more trademarks;
a means for monitoring websites associated with the set of domain names, wherein the monitoring includes recording historical traffic information;
a means for determining an availability list that identifies one or more of the domain names in the set of domain names that are available for purchase or are about to become available for purchase; and
a means for generating an availability notification for each of the one or more domain names in the availability list, wherein the notification includes the historical traffic information collected for each website.

30. The system of claim 29, wherein the set of domain names include variants of trademarks.

31. The system of claim 29, further comprising a means for recording snapshots of the websites over time.

32. The system of claim 29, further comprising a means for determining an expiration date for each domain name in the set of domain names.
